(19) United States
(12) Patent Application Publication
(10) Pub. No.: US 2011/0215112 A1
(43) Pub. Date: Sep. 8, 2011

(54) Water dispenser that flavors and carbonates water

(76) Inventor: Yaniv Bar, Tel Aviv (IL)

(21) Appl. No.: 13/068,495

(22) Filed: May 13, 2011

(30) Foreign Application Priority Data
Dec. 4, 2008 (IL) 195702

(51) Int. Cl. B67D 7/74

(52) U.S. Cl. 222/129.1

(57) ABSTRACT

A water dispenser designed to filter and supply cold, hot and lukewarm water that includes a mechanism for adding flavor to the dispensed water and a mechanism for carbonating the dispensed water. The flavor addition mechanism is installed within the casing of the dispenser and includes one or more base units whereby each of the said base units has a compartment into which a cartridge with flavor substances is installed, an operation system and a small tube that delivers the flavor dose to the dispensed water. The carbonation mechanism includes a base unit with a compartment into which a gas canister is installed, carbonation tank and operation system.

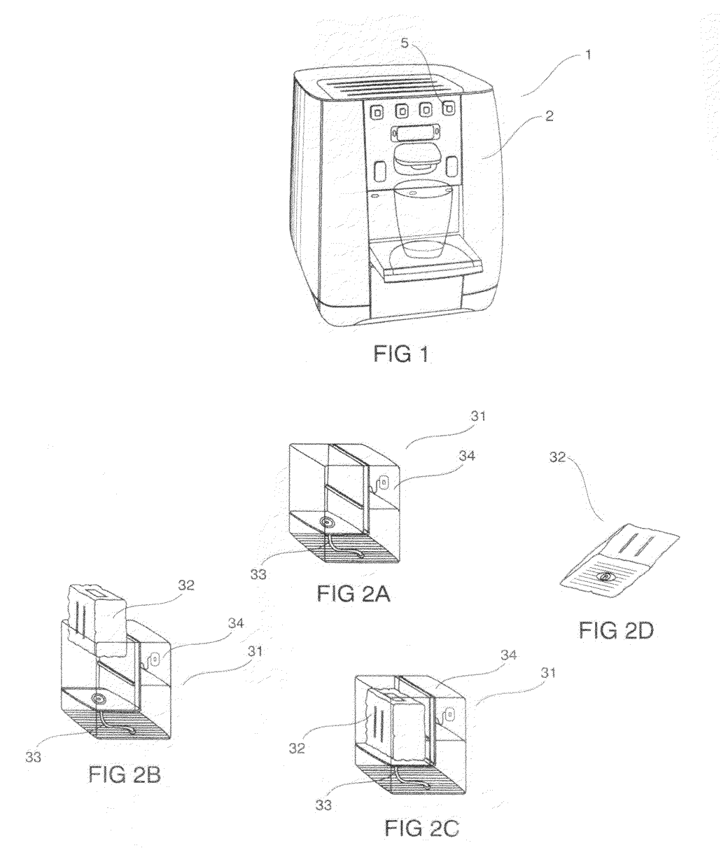

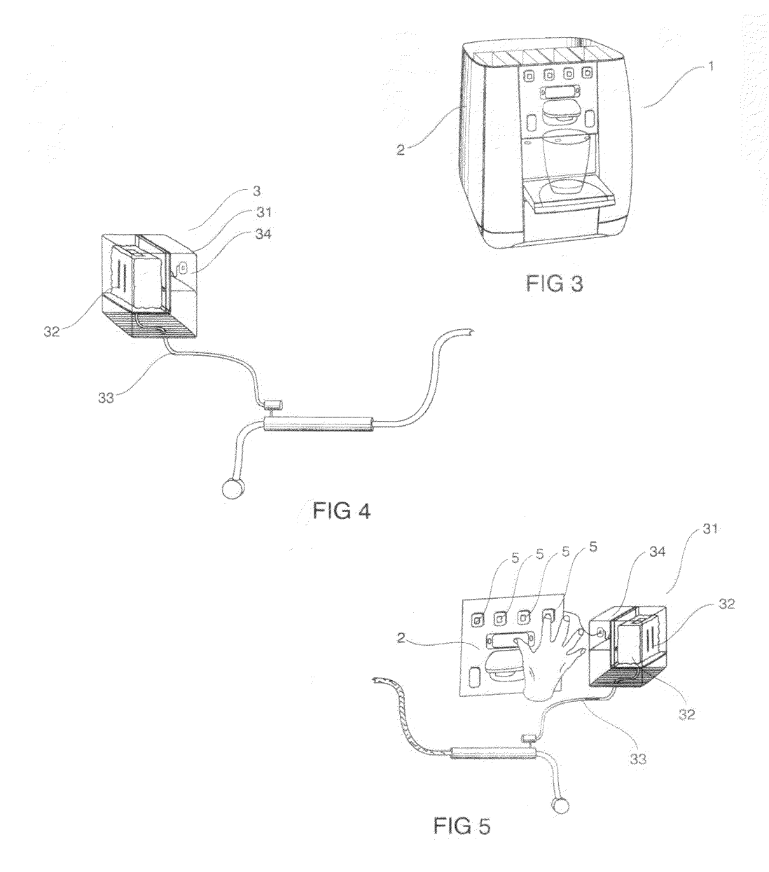

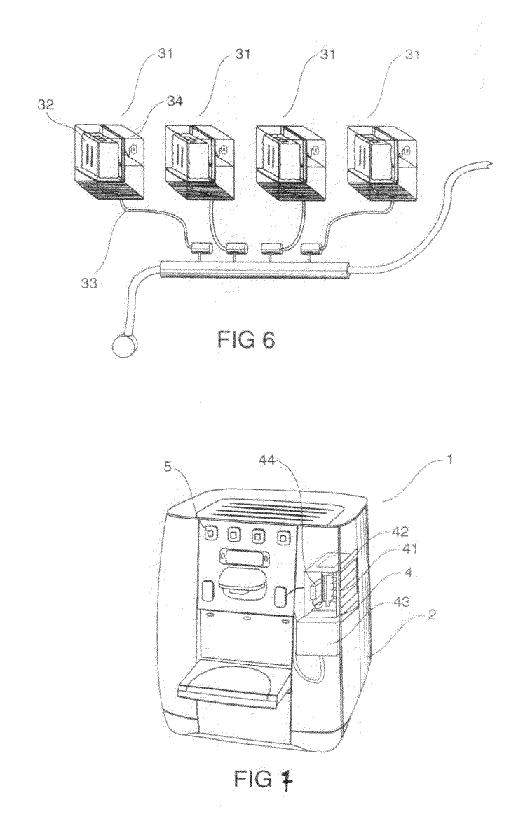

### TECHNICAL FIELD

The present invention refers to a water dispenser, such as the standard water dispensers that are available today, with a mechanism that enables the user to add flavors to the water and a mechanism that enables the user to carbonate the water.

### BACKGROUND ART

Apparatuses designed to filter water, which dispense hot, cold or lukewarm drinking water (hereinafter referred to as “water dispensers”), are installed in many residential homes and other places. Water filtering dispensers made by the Israeli company known by its trade name TAMI4, which manufactures and markets a variety of water dispensers that filter and supply hot, cold and lukewarm filtered water, are known worldwide.

The variety of water filtering dispensers made by this company is described on its website www.tami4.co.il Water dispensers manufactured by TAMI4 are known worldwide also by the name TANAWATER T-6, which are marketed by a company known by its trade name TANAWATER. Filtering water dispensers marketed by this company are described on the website www.tanawater.co.il.

A standard water dispenser includes an external casing which is usually designed in an aesthetic manner since it is intended to be positioned in the kitchen or at some other visible place. The dispenser is connected to the building's regular water piping system. The casing contains a filtration system that filters water incoming from the water piping system. From the filter, the water flows into a hot water tank and a cold water tank. The dispenser includes a piping system and a control system.

The front of the water dispenser has a drip tray on which the user places a cup into which water is dispensed. By pressing a button, the user selects whether the dispenser will dispense cold water, hot water, boiling water or lukewarm water into the cup. So far, we have presented a general explanation and description of a water dispenser, which any average expert in the field is well familiar with.

The present invention is an upgrade of the known water dispenser in that it includes a mechanism that enables the user to optionally add flavors to the water, such as fruit concentrates, vitamin concentrates and so on. The upgrade also includes a mechanism that enables the user to carbonate the dispensed water.

### THE INVENTION

The present invention refers to a water dispenser (1) designed to filter and supply cold, hot and lukewarm water, that included the option of adding flavors and/or carbonating the water dispensed from the dispenser.

The water dispenser (1) in its entirety is designed like any currently (or future) known and available standard water dispenser, with the modification that it includes a mechanism that enables the user to add one or more flavors to the dispensed water and a mechanism that enables the user to carbonate the dispensed water. Since the structure, components, design, and operation principle of the standard water dispenser are familiar to any average expert in the field, it seems that no elaborate or detailed explanation of these issues is necessary here. In the present patent application, we will describe primarily those components that are unique to the water dispenser (1), subject of the present invention.

The main function of the water dispenser (1), subject of the present invention, is to filter water and supply cold, hot or boiling water (as is customary), and also to enable the user to add flavor to the cold water dispensed from the water dispenser using an internal mechanism located within the dispenser (1) that releases a predefined quantity (dose) of concentrate into the portion of water dispensed.

In addition, another function of the water dispenser (1) is to enable the user to carbonate the portion of water dispensed (in other words, to turn it into soda water), using an internal mechanism located within the dispenser (1).

The dispenser (1) includes a casing (2) with a drip tray at its front, on which the user places a cup when dispensing water, a display panel, and a set of operation buttons. The dispenser (1) includes a connection to the regular water piping system, a connection to the electrical mains, a filtration system, and all systems that currently exist in any standard water dispenser. In addition to all of the above, the water dispenser (1), subject of the present invention, also includes a mechanism for adding flavors (3) and a mechanism for carbonating the water (4).

The mechanism for adding flavors (3) comprises a base unit (31), depicted for instance in Drawing No. 2. The base unit is installed in the casing (2). The base unit is designed to contain a flavor cartridge (32), depicted for instance in Drawing No. 2D. The base unit (31) includes a compartment and/or recess into which the flavor cartridge (32) is inserted, as depicted for instance in Drawings 2B and 2C.

The base unit (31) can be permanently built into the casing (2) or it can be designed and installed in such a way that it can be removed from the casing (2), for instance, for the purpose of repairs or replacement in case of need. The base unit (32) includes a small tube (33) whose function is to deliver the flavor dose from the cartridge (32) in the base unit (31) to the water being dispensed from the water dispenser (1). The base unit (31) includes a mechanism (34) whose function is to receive the command (signal) to add flavor to the dispensed water and cause a dose of flavor to flow from the cartridge (32), through the small tube (33), into the dispensed water.

The water dispenser (1) includes a buttons and command system that is designed to enable the user to choose whether to add flavor to the dispensed water. The buttons (5) are depicted, for instance, in Drawing No. 5. The buttons (5) are connected to the mechanisms (34) that are located in the base unit (31). The water dispenser (1) can include an option for adding only one flavor or for adding several flavors. In the drawings attached to the present application, the dispenser (1) is depicted with the option for adding up to four different flavors, and therefore the dispenser (1) depicted has four base units (31).

Each of the base units (31) has a cartridge (32) containing a concentrate of flavoring substances, such as juice concentrates and/or color, flavor, odor and vitamin concentrates as customarily used in the market. Since the dispenser (1) has four base units (31), it can in fact include four kinds of flavors. The present invention refers to a water dispenser that has one or more base units.

The cartridge (32) can be removed from the base unit after it is empty (obviously, it can be replace even before it is empty), and in its place, a new, full cartridge can be installed. The manufacturer of the water dispenser (1) and/or of the cartridges (32) can market a wide variety of flavors and each user can fill the base units (31) of the dispenser (1) with the flavors he or she desires, according to his or her personal taste.

The water carbonation mechanism (4) is depicted in general in Drawing No. 7. The mechanism (4) includes a base unit (41) that is installed in the casing (2) and is designed to contain a gas canister (42). The base unit (41) includes a compartment and/or recess into which the gas canister (42) is installed. The base unit (41) includes a carbonation tank (43) in which the water is carbonated.

The carbonated water then flows through the water dispensing pipe to the water outlet located at the front of the dispenser (1). The base unit (41) includes a mechanism (44) whose function is to receive the command (signal) to carbonate the dispensed water and to cause the carbonation of the water in the carbonation tank (43). The water dispenser (1) includes a button and a command system that are designed to enable the user to choose whether to carbonate the dispensed water. The gas canister (42) can be removed from the base unit (41) after it is empty and replaced with a full canister.

While the present invention has been described in connection with what is considered the most practical and preferred embodiments, it is understood that this invention is not limited to the disclosed embodiments but is intended to cover various arrangements included within the spirit and scope of the broadest interpretation so as to encompass all such modifications and equivalent arrangements.

### DESCRIPTION OF THE DRAWINGS

Drawings 1 and 3 depict the water dispenser (1) in general.

Drawing No. 2A depicts the base unit (31).

Drawings Nos. 2B and 2C depicts the base unit with a flavor cartridge (32).

Drawing No. 2D depicts the flavor cartridge (32).

Drawing No. 4 depicts the flavor mechanism (3) including the base unit (31),

the mechanism (34), the small tube (33) and the cartridge (32).

Drawing No. 5 depicts the flavor mechanism (3) including the base unit (31), the mechanism (34), the small tube (33), the cartridge (32) and the buttons that control the flavor mechanism.

Drawing No. 6 depicts the flavor mechanism (3) including four base units (31).

Drawing No. 7 depicts the carbonation mechanism (4) including the base unit (41), gas canister (42), carbonation tank (43) and operation system (44).

What is claimed is:

1. A water dispenser designed to filter and supply cold, hot and lukewarm water that includes a mechanism for adding flavor to the dispensed water.

2. A water dispenser designed to filter and supply cold, hot and lukewarm water that includes a mechanism for carbonating the dispensed water.

3. The water dispenser mentioned in claim 1 whereby the said mechanism for adding flavors includes one or more base units and each of the said base units has a compartment into which a cartridge containing flavor substances is installed, an operation system and a small tube that delivers the flavor dose to the dispensed water.

4. The water dispenser mentioned in claim 2 whereby the said carbonation mechanism includes a base unit with a compartment into which a gas canister is installed, a carbonation tank and an operation system.
